(19) United States
(12) Patent Application Publication
(10) Pub. No.: US 2020/0273653 A1
(43) Pub. Date: Aug. 27, 2020

(54) EXPLOSION-PROOF FUSE

(71) Applicant: CONQUER ELECTRONICS CO., LTD., Taipei City (TW)

(72) Inventor: Hung-Chih Chiu, Taipei City (TW)

(21) Appl. No.: 16/286,524

(22) Filed: Feb. 26, 2019

(51) Int. Cl. H01H 85/17; H01H 85/041; H01H 85/08

(52) U.S. Cl. CPC H01H 85/17; H01H 85/08; H01H 85/0415

(57) ABSTRACT

An explosion-proof fuse includes: at least one first tube, an inside thereof configured with an alloy wire, a length of the alloy wire is larger than the one of the first tube, allowing each end of the alloy wire to be extended out of the first tube; at least one second tube, covered on and combined with an outside of the first tube, and an length of the second tube being larger than the one of the first tube; a plurality of isolating fixing member, each filled inside the second tube and stuck to an respective end face of the first tube, and each isolating fixing member covered on an outside of the alloy wire; and a plurality of covers, each in combined with a respective end of the second tube, an inner side of the cover in combination with a respective end of the alloy wire.

### TECHNICAL FIELD OF THE INVENTION

The present invention relates to a fuse for electric equipment, and more particularly to an explosion-proof fuse, having an excellent electric arc insolation and explosion-proof effect.

### DESCRIPTION OF THE PRIOR ART

Fuses are broadly used in electronic products and electrical products so as to prevent the products from being damaged by overlarge current. The protection principle thereof is that the conductive fuse wire with a proper impedance is blown due to overheating so as to stop current entering a product when the current beyond rated current passes it; the higher the blown impedance is, the better the current isolation is. Usually, the larger the section of a fuse wire is, the smaller the impedance thereof is and the larger the rated current is. A fuse is connected in series to a circuit protected by it so that the less voltage drop and temperature rise are the better when used within rated current range. When the fuse wire is heated by overlarge current, it will generate an electric arc before completely blown; the electric arc is generated instantaneously and has local high energy, which is very destructive and thus is an important factor for the design and manufacturing thereof,

### SUMMARY OF THE INVENTION

To overcome the defects mentioned above, the present invention proposes an explosion-proof fuse, including: at least one first tube, an inside thereof configured with an alloy wire, a length of the alloy wire is larger than the one of the first tube, allowing each end of the alloy wire to be extended out of the first tube; at least one second tube, covered on and combined with an outside of the first tube, and an length of the second tube being larger than the one of the first tube; a plurality of isolating fixing member, each filled inside the second tube and stuck to an respective end face of the first tube, and each isolating fixing member covered on an outside of the alloy wire; and a plurality of covers, each in combined with a respective end of the second tube, an inner side of the cover in combination with a respective end of the alloy wire.

### BRIEF DESCRIPTION OF THE DRAWINGS

FIG. 1 is a perspective view of the present invention; and

FIG. 2 is a cross-sectional view of the present invention.

### DETAILED DESCRIPTION OF THE PREFERRED EMBODIMENTS

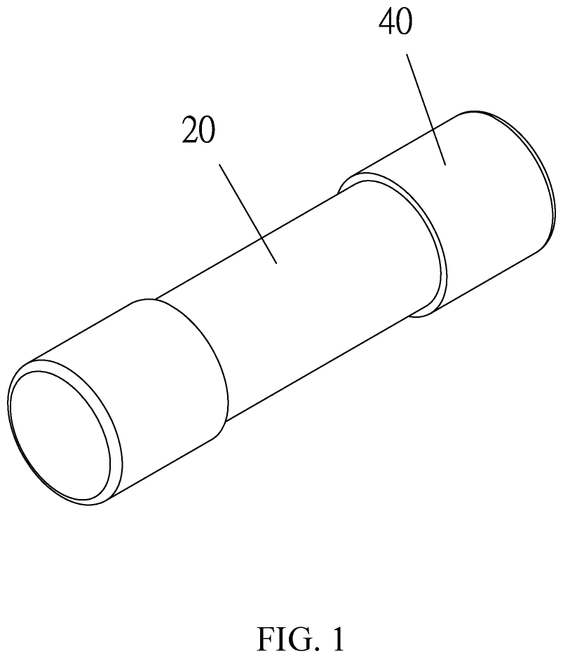

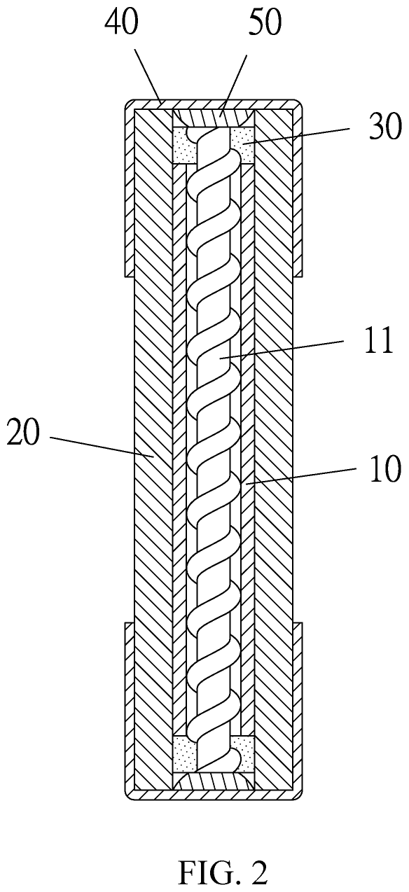

Referring to FIGS. 1 and 2, an explosion-proof fuse of the present invention includes at least one first tube 10, at least one second tube 20, a plurality of insulating fixing member 30 and a plurality of covers 40

The inside of the first tube 10 is configured with an alloy wire 11, the length of which is larger than the one of the first tube 10, allowing the two ends of the alloy wire 11 each extended out of the first tube 10.

In a preferred embodiment, the first tube 10 is made of quartz glass.

The second tube 20 is covered on and combined with the outside of the first tube 10, and the length thereof is longer than the one of the first tube 10.

In the preferred embodiment, the second tube is made of ceramics, and the thickness of the wall thereof is larger than the one of the wall of the first tube 10.

The isolating fixing member 30 is respectively filled inside the second tube 20 and stuck to each end face of the first tube 10, where each isolating fixing member 30 is covered on the outside of the alloy wire 11.

In the embodiment, each isolating fixing member 30 is made of silicone.

The cover 40 is respectively in combination with the two ends of the second tube 20, where the inside of the cover 40 is further respectively in combination with the two ends of the alloy wire 11.

Each end of the alloy wire 11 is jointed to the cover 40 with solder 50.

1. An explosion-proof fuse, comprising:
at least one first tube, an inside thereof configured with an alloy wire, a length of said alloy wire is larger than a length of said at least one first tube, allowing each of ends of said alloy wire to be respectively extended out of ends of said at least one first tube;
at least one second tube, covered on and combined with an outside of said at least one first tube, and a length of said at least one second tube being larger than the length of said at least one first tube;
a plurality of isolating fixing members, each filled inside said at least one second tube and stuck to an end face of each of the ends of said at least one first tube, wherein each isolating fixing member of the plurality of isolating fixing members is covered on an outside of said alloy wire; and
a plurality of covers, each combined with a respective one of ends of said at least one second tube, wherein an inner side of each cover of the plurality of covers is combined with a respective end of said alloy wire,
wherein said at least one second tube comprises an intermediate section between the ends of said at least one second tube, the intermediate section having a predetermined length, such that the predetermined length of the intermediate section of said at least one second tube corresponds to and covered on and directly combined with said at least one first tube along entirety of the length of said at least one first tube, the plurality of isolating fixing members being respectively stuffed in the ends of said at least one second tube and stuck to the end faces of said at least one first tube to be interposed between said plurality of covers and the end faces of the ends of said at least one first tube.

2. The fuse according to claim 1, wherein the ends of said alloy wire are respectively jointed to the plurality of covers with solder.

3. The fuse according to claim 1, wherein said at least one first tube is made of quartz glass, and said at least one second tube is made of ceramics.

4. The fuse according to claim 1, wherein a thickness of said at least one second tube is larger than a thickness of said at least one first tube.

5. The fuse according to claim 1, wherein said plurality of isolating fixing members are made of silicone.
